(19) United States
(12) Patent Application Publication
(10) Pub. No.: US 2021/0306206 A1
(43) Pub. Date: Sep. 30, 2021

(54) SYSTEM FOR IMPLEMENTING A DATA PROTOCOL ENABLED APPLICATION

(71) Applicant: EOS Defense Systems USA, Inc., Huntsvillle, AL (US)

(72) Inventors: Michael K. Bugenhagen, Santa Clara, CA (US); Sunil Praful Shah, San Jose, CA (US); Ranjit Vadlamudi, San Jose, CA (US); Mark B. Saxelby, Milpitas, CA (US); Abelino C. Valdez, Tracy, CA (US)

(21) Appl. No.: 17/212,981

(22) Filed: Mar. 25, 2021

Related U.S. Application Data
(63) Continuation-in-part of application No. 16/802,457, filed on Feb. 26, 2020.
(60) Provisional application No. 62/994,850, filed on Mar. 26, 2020.
(60) Provisional application No. 62/811,500, filed on Feb. 27, 2019.

(51) Int. Cl. H04L 12/24; H04L 12/707; H04L 12/18; H04L 12/26; H04L 29/08

(52) U.S. Cl. CPC H04L 41/0668; H04L 45/24; H04L 67/12; H04L 43/0817; H04L 12/1868

(57) ABSTRACT

Novel tools and techniques are provided for implementing a DLP resource as a User managed cloud resource with compliance tools, automated service delivery, federate-able cloud single sign-on, and agile resource integration. A method for implementing a communication network for an Internet of Thing (IoT) application includes establishing a multi-path connection among data link protocol (DLP) nodes. One of the DLP nodes is an IoT device. Each DLP node includes a slow agent and a fast agent. A first DLP node determines a second DLP node has failed. The second DLP node is associated with a role in the communication network. The first DLP node transmits a DLP frame carrying the control message to the plurality of DLP nodes. The first DLP node re-establishes a connection with a third DLP node based on the control message. The third DLP node takes over the role of the second DLP node.

### CROSS-REFERENCE To RELATED APPLICATIONS

This application is a continuation-in-part of U.S. patent application Ser. No. 16/802,457, filed on Feb. 26, 2020, which claims priority to Provisional Patent Application Ser. No. 62/811,500, filed on Feb. 27, 2019. This application also claims priority to Provisional Patent Application Ser. No. 62/994,850, filed on Mar. 26, 2020. The subject matter of all of these applications are incorporated herein by reference in their entirety.

### TECHNICAL FIELD

This description relates to control plane agents and protocols in a telecommunication network, such as in the data link layer.

### BACKGROUND

Free Space Optics can transmit at extremely high rates but have a vulnerability to short duration transmission interruption caused by atmospheric impairments or objects interfering with the beam. Conventionally, re-transmission occurs at other layers than the data link layer such as the physical layer or the Internet Protocol layers. High-speed re-transmission occurring at the physical layer is problematic due to vendor chip inter-operability, and the cost of changing optics to upgrade or improve the transmission facilities. Transport layer protocols such as TCP (transmission control protocol) have flow level transmission correction, however, TCP mechanisms are impacted by round-trip delays, and packet loss and use throughput throttling with exponential back-off before restoring throughput to the flow. These methods are both crude and too lengthy to provide transmission control over a wireless or FSO link and are also unsuitable due to the impacts on the service state machines that are reacting in the milliseconds duration. These mechanisms could also create race conditions and low-quality services for any real-time communication across a link subject to packet loss such as FSO, and unregulated wireless spectrum.

With the advent of higher speed Central Processing Units that can run at “line rate” (transmission rates) in the gigahertz speed, Network Processing Units (NPU) and more programable data path functions and applications have emerged and are now capable of replacing dedicated Application Specific Integrated Circuits (ASIC). This new programmable environment allows for functions of the data link layer performing at rates normally only viable at the physical transmission layer.

### SUMMARY

Novel tools and techniques are provided for implementing a DLP resource as a User managed cloud resource with compliance tools, automated service delivery, federate-able cloud single sign-on, and agile resource integration. A method for implementing a communication network for an Internet of Thing (IoT) application includes establishing a multi-path connection among a plurality of data link protocol (DLP) nodes. At least one of the DLP nodes being an IoT device. Each DLP node includes a slow agent and a fast agent. The slow agent is configured to transmit data payloads through Ethernet frames. The fast agent is configured to transmit control messages through DLP frames. Each DLP frame includes a header only without a payload and the header carrying a control message. The method also includes determining, at a first DLP node of the plurality of DLP nodes, a second DLP node has failed. The second DLP node is associated with a role in the communication network. The first DLP node transmits a DLP frame carrying the control message to the plurality of DLP nodes in the communication network. The first DLP node re-establishes a connection with a third DLP node based on the control message. The third DLP node takes over the role of the second DLP node.

In yet another embodiment, a non-transitory computer readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF DRAWINGS

Embodiments of the disclosure have other advantages and features which will be more readily apparent from the following detailed description and the appended claims, when taken in conjunction with the examples in the accompanying drawings, in which:

FIG. 1 is a block diagram of a system environment of an example telecommunication network, according to an embodiment.

FIG. 2A is a block diagram illustrating an example framework of network nodes in a telecommunication network, according to an embodiment.

FIG. 2B is a block diagram illustration a reference system architecture a data link protocol (DLP) framework, according to an embodiment.

FIG. 3A is a generalized reference architecture for control and user information paths, according to an embodiment.

FIG. 3B is an illustration of legacy LAG (link Aggregation Group) path protection versus DLP path protection, according to an embodiment.

FIG. 4 is an illustration of control signaling multiple IP control sessions versus a BUS architecture where messages are available across the BUS, according to an embodiment.

FIG. 5 is an illustration of agent/controller-based fail-over that is forced without a BUS architecture versus the Fast failover of a BUS architecture, according to an embodiment.

FIG. 6 is an illustration of the different messages capabilities of a BUS architecture where any point can talk to any point and be exposed to other nodes and or their functions, according to an embodiment.

FIG. 7 is an illustration of DLP across multiple providers for highly resilient services, according to an embodiment.

FIG. 8 is an illustration of the DLP IP gateway functionality that enables routing message interfaces via IP address, and port, according to an embodiment.

FIG. 9 is an illustration of a DLP Loop back address used for pings and delay testing, according to an embodiment.

FIG. 10 is an illustration of a DLP frame based reference architecture, according to an embodiment.

FIG. 11 is a block diagram illustrating components of an example computing machine, according to an embodiment.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Telecommunication and cloud computing co-utilization has decentralized resources, controls and end devices which primarily use IP codecs and agents for control signaling. At the same time the network data plane on which the user data is transported has moved from TDM (Time Division Multiplexing), where the state of the transport and path were communicated end to end via “yellow” and “red” alarm signals so that all points along the path knew the state, to a link based data path where the user needs to place agents on the data plane to attempt to understand the nature of the path.

Account based services are conventionally centric to a service point, where call handling, end device control, and customer account management occur. Originally, TCP/IP (Transmission Control Protocol/Internet Protocol) was used to attempt to control signaling due to its ability to recover lost control frames. However, operation of the IP transmission control protocol is an order of magnitude too slow to make control decisions, so the control frames where moved to UDP (User Datagram Protocol) packets, which are not protected by the IP layer. This exposes control signaling to packet or frame loss and shifts the responsibility to work through the loss to the signal control agents on the devices of interest.

Current path protection in Ethernet is “link based” LAG (Link Aggregation Group), which only occurs between nodes of a single provider. LAG has no user control or QoS mapping capabilities. LAG also does not provide channel availability information to the application layer. LAG is an “invisible to the user” way to automatically move traffic off a failed path and is often disconnected with other layers or applications. IP and IP/MPLS (Multiprotocol Label Switching) routing use a combination of network discovery and routing table updates to determine the routing tables of the entire packet network uses. However, these routing protocols do not really interact with the application layer without considerable integration and higher cost managed services.

Ethernet is generally available across all providers and it provides the transportation speed and cost structure required for services. However, it does not provide fail-over across providers. It also fails to provide a fast signaling path without the use of IP based codecs or agents. The lack of those capacities force the control framework into multiple sessions on different paths that require the end points to manage fail-overs.

The present disclosure is related to methods, systems, and apparatuses for implementing a data link protocol (DLP) enabled application and instrument network link for various applications such as artificial intelligence (AI), machine learning (ML), Internet of Things (IoT), other software applications, financial trading, gaming, video streaming, over diverse technologies and provider networks. An example use case is leveraging the DLP transmission protection which is path based versus linked based, and the use of the DLP header message agents and path to enable fast failover control. This use case covers both end device to controllers and resources, controller to controller, and resource to resource applications, including the end device to the controller or resource path. It should be noted the end device can be a sensor, actuator, application, robot, etc. The innovation provides devices with resilient connectivity and a line rate signaling BUS. Such a line rate signaling BUS enables a control framework to overcome transport packet and frame loss. Embodiments remove the limits of IP based sessions, which are end-to-end in nature that cause controllers significant control and signaling hand off issues that result in less than industrial or carrier grade control behavior.

Various embodiments provide tools and techniques for implementing the DLP enabled application, IoT, AI, ML, etc., on a node between computing nodes or between an end device and a computing node. The software applications have access to the message agents in the DLP so that the applications may use the DLP message agents to communicate system messages. The DLP protocol described here is an evolved DLP framework that uses dual message agents (both fast and slow). The DLP protocol also supports an insertion of a header into the user information frames for handling and message exchange. Given DLP is a link based protocol, it can be deployed on dedicated devices, nodes, and entire facilities, which may collectively be referred to as computing nodes in this disclosure. DLP includes the header, message agents, messages and other functions that may be implemented in various ways at various layers of computing, such as ASIC (application specific integrated circuit), network interface card, network processing unit, virtual switch, physical switch, and other various locations. The functionality and framework in these various layers of computing can be the same.

In various embodiments, the DLP functions are placed on computing nodes to support providing applications with resilient transport across multiple technology links, semi-reliable wireless, free space optics, multiple carriers, or a combination of any of these connectivity methods. In some embodiments the DLP header switching and message handling functions are implemented above the network layer of the platform up into the virtualization, switching, and/or BUS layers of the platform, and even into the application layer itself where an application maps directly into a DLP header and messaging agent(s).

In various embodiments, a DLP application uses sub-second performance metrics and states contained within the DLP agents to make application and control decisions, regardless of where the DLP message agents and headers are located.

In various embodiments, conventional applications may not necessarily need to be aware of the DLP technology but simply rely on the underlying resilient transport.

In various embodiments, a software application can be DLP aware and may classify its own traffic into flows with DLP headers that are treated by transmission control functions such as multi-path, ARQ (automatic repeat request), packet loss correction, etc.

In various embodiments, the DLP agents utilize multiple WAN links from different providers, technologies, etc. on the WAN side to provide computing to computing node transport protection.

In various embodiments, the DLP agents utilize multiple LAN links to provide highly resilient connectivity to end devices, sensors, IoT, AI, robotics, and other critical control agents, and or nodes.

In various embodiments, applications use the DLP reserved message header space for application to application control messaging.

In various embodiments, the DLP agents are configured to transmit a fast path message to multiple functions at multiple nodes.

In various embodiments, the applications, controllers, and resources use the DLP gateway function to tunnel IP sessions and VPN (virtual private network) through the DLP fast path.

In various embodiments, a DLP agent loop back address is used for system monitoring, troubleshooting, delay estimation, etc.

In various embodiments, a telecommunication network using a protected signaling control BUS across multi-path protection of the message is described.

In various embodiments, an application and virtual switch that create and place a header and have the information for the performance management are implemented inside the application itself, which means multiple DLP functions can be placed in a serial path.

In various embodiments, a header based messaging bus with gateway functions to enable controlled mapping of messages to any function along the path is implemented. The nodes may choose protection along the path at line rate.

In various embodiments, the DLP protocol network enables fast fail-over and hot swap in a broadcast-like control signaling method. For example, a multi-path system is used so that a control message may be broadcast to various nodes.

In various embodiments, the DLP protocol network may use a DLP header fast path singling path across an IoT architecture to facilitate the IoT/ML/AI architecture regardless of transport or provider.

In various embodiments, the DLP protocol network includes ARQ for resiliency between end device & controller.

In various embodiments, the DLP protocol network uses the fast path to do controller to controller signaling.

In various embodiments, the DLP protocol network uses the fast path for sensor to controller hand offs.

In various embodiments, the DLP protocol network uses statistics on each path for ML/AI to do advanced fail-overs.

In various embodiments, the DLP protocol network selects controllers based on performance metrics of the fast agent.

In various embodiments, the IoT/ML/AI agents use the “delay” line characteristics off each path to adjust message signal transmissions (coordination of actions) across the IOT/ML/AI system outputs and inputs.

In various embodiments, carrier performance reporting of the path management is provided with sub-second availability.

In various embodiments, the DLP protocol network uses advanced IoT information from agent metrics which provide users with LAN (wired or wireless) flaky path detection for preparation for failover alarming.

In various embodiments, the DLP protocol network uses IP gateway functionality using the fast path header message.

In various embodiments, the DLP protocol network uses new header space for messages from other applications.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

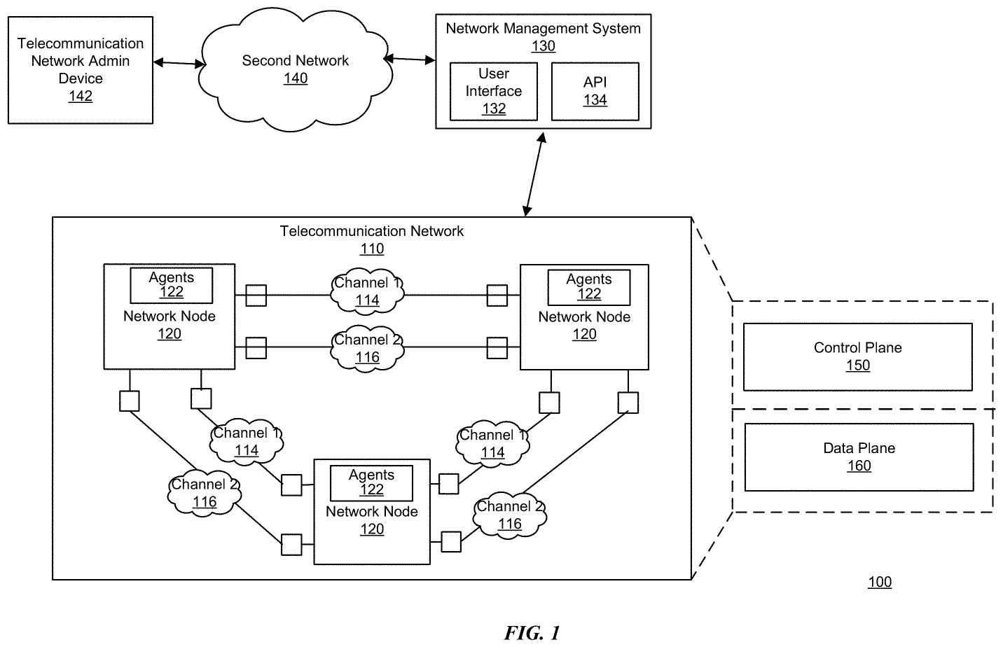

FIG. 1 through FIG. 11 illustrate various features related to methods, systems, and apparatuses for implementing a data link protocol (DLP) as part of a bearer path, management BUS, and command and control plane or layer across multiple nodes, technologies, and connectivity providers for applications, resources, controllers, etc.

FIG. 1 is a block diagram illustrating a system environment 100 of an example telecommunication network 110, according to an embodiment. The system environment 100 includes the telecommunication network 110, which includes two or more network nodes 120, a network management system 130, a second network 140, and a telecommunication network administrator device 142. In various embodiments, the system environment 100 may include fewer or additional components. The system environment 100 may also include different components. The components in system environment 100 may be deployed in one or more physical devices and embodied in software, firmware, hardware, or any combinations thereof.

Telecommunication network 110 may be any communication network that transmits data and signals by any suitable channel media such as wire, optics, waveguide, radio frequency, or another suitable electromagnetic medium. The telecommunication network 110 can be of any scale from near-field to a satellite wireless network, including local area network (LAN), metropolitan area network (MAN), wide area network (WAN), long-term evolution (LTE) network, or another suitable communication network whose scale and area of coverage may not be commonly defined. The components in telecommunication network 110 do not need to be confined in the same geographic location. For examples, the network can be established with nodes that are distributed across different geographical locations. Also, some of the nodes may be virtualized. The telecommunication network 110 includes two or more network nodes 120 that communicate with each other through one or more channels 114, 116, etc. While three example network nodes arranged in a ring are shown in FIG. 1, telecommunication network 110 can be in any topologies, such as point-to-point, star, mesh, chain, bus, ring, and any other suitable, regular or irregular, symmetric or not, cyclic or acyclic, fixed or dynamic (e.g., with one or more network nodes 120 moving) topologies. The telecommunication network 110 may include wireless communication between network nodes 120 that are carried by (e.g., mounted on, integrated in, or otherwise embedded) building sides, towers, other structures, surface ships, floating platforms at sea, submersible vehicles, ground vehicles such as cars or trains, airborne platforms such as airplanes, balloons, dirigibles, and other fixed- or non-fixed-wing aircraft, space platforms such as satellites, space stations, manned space vehicles, space probes, and other space vehicles.

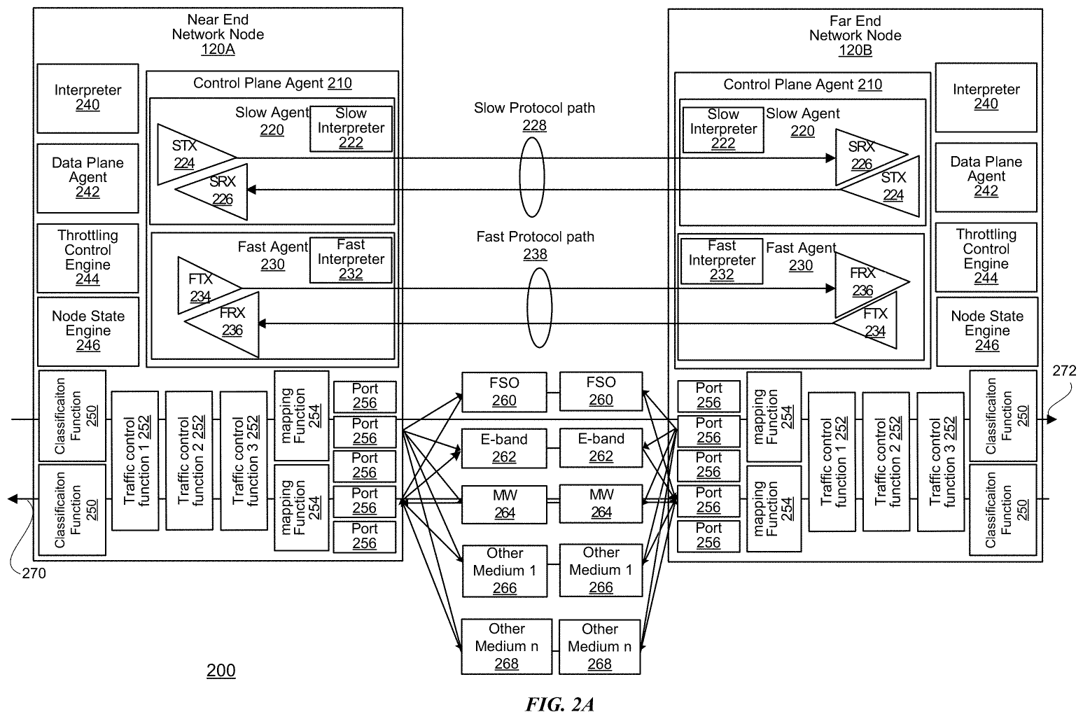

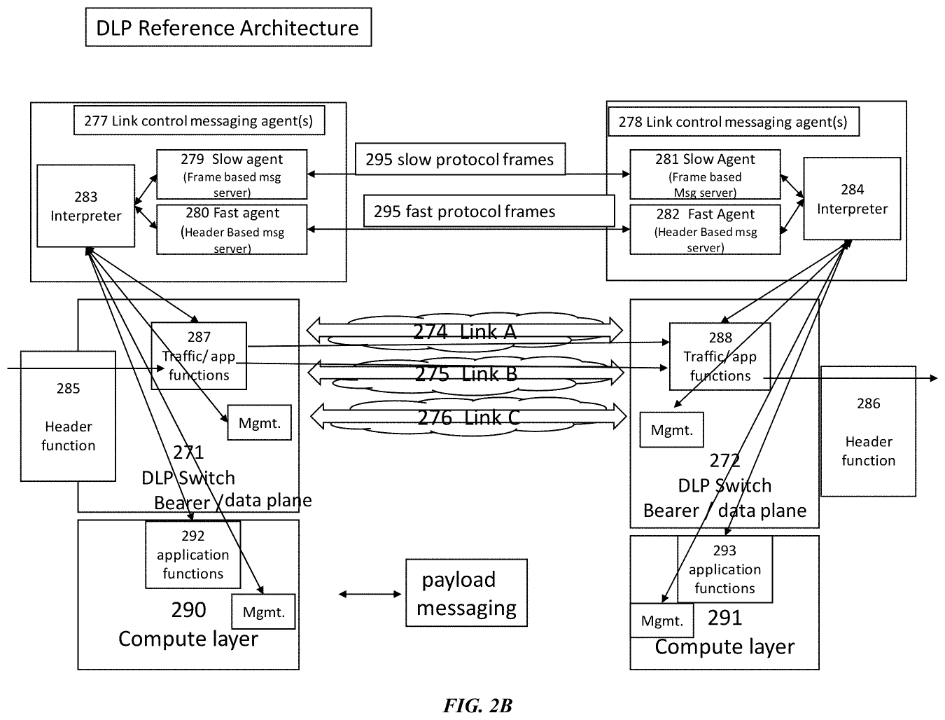

Network nodes 120 may be any suitable distribution points, redistribution points, or endpoints of telecommunication network 110. Network nodes 120 may also be referred to as simply nodes 120 and may take the form of a communication instrument, a base station, a physical node, a virtual switch, a computing node, a cloud resource, or any suitable computing device that is equipped with one or more network protocols. Each network node 120 may include one or more agents 122. Different types of agents 122 in a node 120 will be discussed in further detail below with reference to FIG. 2A. Network nodes 120 can be any suitable data communication equipment for encoding and transmitting data frames in one or more physical layer channels. Depending on embodiments, one or more network nodes 120 can take form of gateways, routers, switches, hubs, modems, base stations, terminals, wireless access points, Internet of Things (IoT) devices, etc. that may be carried by fixed structures or mobile equipment such as satellites, vehicles, autonomous vehicles, drones, or portable electronic devices. In other words, a node 120 may be any suitable infrastructure or equipment that may be used to transmit or re-distribute data to another node 120. The node may also be virtualized and a software-implemented node that can be part of a computing device or a cloud resource. Each node 120 may communicate with another node 120 through one or more channels 114, 116, etc. of similar or dissimilar technology types. Channels 114 and 116 can be of any suitable channel media such as free space optical (F SO) communication, E-band, microwave, mobile wireless, fixed wireless, a wired connection, an Ethernet-based transport facility, or another suitable medium. A channel may also simply be the Internet. Channel 114, channel 116, and other channels may also be using the same medium but with different frequencies such as radio frequency using Wi-Fi frequency band, LTE frequency band, ultra-high frequency (UHF) band, etc. Also, the channels 114 and 116 may also use the same type of medium. For example, channel 114, channel 116, and other channels may be several FSO channels with spatial diversity. While all three of the network nodes 120 in FIG. 1 are shown to be connected by channel 114 and channel 116, any pair of network nodes 120 in telecommunication network 110 may be communicated with each other in channels that are different from those used in another pair of network nodes. For example, FSO may be available between some of the network nodes 120, but not between every node 120.

Telecommunication network 110 may be divide logically, structurally, and/or architecturally into a control plane 150 and a data plane 160. The control plane 150 and data plane 160 are different functional layers of the telecommunication network 110 and may have separate or shared hardware and architecture, but may be separately controlled and maintained through software and sometimes certain separate hardware. Data plane 160 may be the part of the telecommunication network 110 that is used to transmit data payloads. Data payloads are live data traffic that is transmitted by network users through the telecommunication network 110. For example, website data, emails, multimedia data, and other suitable Internet packets may be transmitted through the telecommunication network 110 and are examples of data payloads. Channels 114 and 116 that are used by the data plane 160 are often operated at the line rate or close to the line rate to enable data payloads to be transmitted as fast as possible through telecommunication network 110. Data plane 160 may also be referred to as the bearer plane. Data plane 160 may contain header-based flow identifiers.

Control plane 150 may be a function layer of the telecommunication network 110 that is used to transmit information related to changes, additions, or removal of various settings and protocols of the telecommunication network 110. For example, control plane 150 is used to transmit control messages that are used to adjust the settings of one or more network nodes 120, the entire telecommunication network 110, certain channels 114 and 116, etc. Messages intended for the control plane 150 may be referred to as control plane messages, which may carry parameters and/or instructions to change one or more settings of a component in the telecommunication network 110. One example of a control plane message may be a message that carries instructions related to a traffic control function. Another example of a control plane message may include a packet or any messages that are intended for layers that are higher than data link layer. A control plane message may also be transmitted from a node 120 to the network management system 130 and carry state information (e.g., status information) or feedback information of a component of a node 120. Types of control plane messages may include operational messages, administration messages, maintenance messages, provisioning messages, troubleshooting messages, etc. The protocol agents 122 may include settings of a component in the telecommunication network 110. The settings may be associated with traffic control functions (TCFs), flow classification functions, mapping functions, quality of service settings, throttling management, traffic management, error control mechanisms, error correction mechanisms, data link layer protocols, multiplexing protocols, delay protocols, rate limits, scheduler types, port settings, virtual LAN (VLAN) settings, physical layer encoding protocols, physical layer error correction schemes, etc. Control plane messages are distinct from data payloads transmitted in the data plane 160 and are used to control the telecommunication network 110. It should be noted that the term control plane message may apply to protocol, configuration, and signaling messages between the agents (both fast and slow), and between the TCFs which can be mapped or encoded into the fast and slow agents.

Control plane 150 used in this disclosure may include both a control plane and a management plane. For example, in some embodiments, a control plane may handle control and protocol messages that are intended for sharing among network nodes 120 (which may be commonly referred to as east and west bound messages). A management plane, on the other hand, may handle control and protocol messages that are originated from a device outside the telecommunication network 110 or from a third party through the network management system 130 (which may be commonly referred to as north bound messages). In the embodiments that further divide control plane 150 into a control plane and a management plane, the messages intended for the management plane may be referred to as operations, administration, or management (OAM) messages. However, for embodiments that further divide control plane 150 into a control plane and a management plane, the term control plane message may include both messages intended for the control plane and the messages intended for the management plane, including OAM messages.

Network management system 130 may be a server or any computer that is used to manage the telecommunication network 110. The network management system 130 may transmit one or more administration, control and configuration messages to a node 120. In some embodiments, the network management system 130 may directly communicate with every node 120 in the telecommunication network 110. In another embodiment, a node 120 that received the messages may propagate the messages to one or more other network nodes through the control plane 150. The control plane messages may be intended for all network nodes 120 or a subset of network nodes 120. The network management system 130 may provide a user interface 132 for a network administrator (e.g., a customer that purchases or leases the infrastructure of telecommunication network 110) to control and adjust one or more settings of telecommunication network 110. The user interface may take the form of a graphical user interface (GUI) to provide visual information and data for the network administrator. The network management system 130 may also include an application programming interface 134 (API) for a network administrator to use programming languages to communicate with the network management system 130. The network management system 130 may also communicate with third party systems over which the network administrator device 142 may receive information relevant to network components managed outside of the network management system 130.

A network administrator may use a telecommunication network administrator device 142 to communicate with the network management system 130 through a second network 140. The telecommunication network administrator device 142 may be one or more computing devices such as desktop computers, laptop computers, personal digital assistants (PDAs), smartphones, tablets, wearable electronic devices (e.g., smartwatches), smart household appliance (e.g., smart televisions, smart speakers, smart home hubs), Internet of Things (IoT) devices or other suitable electronic devices. The telecommunication network administrator device 142 may communicate with the network management system 130 through the user interface 132 and/or API 134. The second network 140 may be any suitable network such as the Internet, 4G, LTE, 5G, LAN, or a direct line. Telecommunication network 110 may or may not be part of the second network 140. In some embodiments, a network administrator may remotely control the settings of the telecommunication network 110 through sending commands via the Internet to the network management system 130. For example, a network engineer of a telecommunication company may control the telecommunication network 110 using API 134 through the Internet at the engineer's normal place of work. In another embodiment, a network administrator may be local to the telecommunication network 110 and he may control the network 110 through a local area network (e.g., WI-FI) or even a direct ethernet cable. As discussed in further detail below with reference to the section “Management of Telecommunication Network” below, a network administrator may dynamically change settings of telecommunication network 110.

FIG. 2A is a block diagram illustrating the architecture of two example network nodes 120 in the telecommunication network 110, according to an embodiment. FIG. 2A illustrates an example framework 200 for carrying out various functions and protocol in this disclosure, according to an embodiment. The two example network nodes 120 may be referred to as a near end network node 120A and a far end network node 120B. Near end network node 120A represents a transmitting side of a network and far end network node 120B represents a receiving side of the network. In a fully duplex network, near end and far end network nodes may be equivalent. Unless further specified, these network nodes may simply be referred to as network nodes 120. Near end network node 120A and far end network node 120B may also simply be referred to as a first network node and a second network node. For a message that is received at a far end network node 120B, the message may be intended for the far end network node 120B and/or intended for another network node 120 in the telecommunication network. If the message is intended for the far end network node 120B, the far end network node 120B will process the message. If the message is intended for another network node 120, the far end network node 120B will become the near end network node 120A for the next round and forward the message to another network node 120. The message can be a control message or a data message.

A network node 120 may include a control plane agent 210, an interpreter 240, a data plane agent 242, a throttling control engine 244, a node state engine 246, and ports 256 that include or are connected to channel equipment (e.g., antennas, laser transmitters, waveguides, cables) for transmission of signals. The control plane agent 210 may be a data link layer agent. In various embodiments, a network node 120 may include fewer or additional components. A network node 120 may also include different components and the functionality of each component may also be distributed to another component or among other components. Each component may be implemented using a combination of software and hardware. For example, each network node 120 may include memory for storing instructions that define one or more software engine and one or more processors for executing the instructions to perform one or more processes described in this disclosure.

A control plane agent 210 is a data link layer agent that may be implemented as a software engine that is executed on one or more types of processors for different computations and functionalities. The control plane agent 210 manages the protocols, traffic control functions, and frameworks for transmitting and routing control plane messages to various network nodes 120. The control plane agent 210 may include a slow agent 220 and a fast agent 230 that may be run on the same or different types of processors to transmit and process messages at different speeds. For example, in some embodiments, the slow agent 220 includes instructions that are executed on a generic processor such as a central processing unit (CPU) to process and route regular control plane messages. The fast agent 230 includes instructions that are executed on a specialized processor such as a network processing unit (NPU) that may be also used by the data plane. In another embodiment, the fast agent 230 may be run on a field-programmable gate array (FPGA) or another suitable processor. Control plane messages processed by the NPU may be expedited and transmitted using a fast protocol path 238 at the line rate of a channel or the rate of data plane 160. The slow agent 220 may transmit messages using a slow protocol path 228 at the rate of the control plane 150 that is set by the administrator of the telecommunication network 110. The slow agent 220 includes a slow transmitter function 224 and a slow receiver function 226. The fast agent 230 includes a fast frame header insertion function 234 and a fast frame header retrieval function 236.

Interpreter 240 may be implemented as a software engine that is executed on one or more types of processors for deciding various protocols, functions, ports, channels, quality of service (QoS) requirements. The interpreter 240 may be run on a processor separate from the processors used by slow agent 210 and the processor used by fast agent 230. A control plane message may include mapping information associated with how the control plane message should be transmitted. For example, part of the mapping information may take the form of metadata of the control plane message. In some cases, part of the mapping information may also be inherent in the type of control plane message and/or sender of the control plane message. Interpreter 240 may receive and map TCF-related control plane messages to the slow agent 220 or the fast agent 230 for transmission to a far end network node 120B. At the far end network node 120B, the slow agent interpreter 222 or the fast agent interpreter 232 reverses the process to map the TCF-related control plane messages to the related TCFs.

The control plane agent 210 controls and holds the configuration for the flow mappings from the classification function 250 to map information payload and control plane messages into a path (e.g., one or more channels using one or more ports 256) and QoS treatment to provide the basis for applying switching, mapping, and/or traffic control to specific traffic classifications. The control plane agent 210 may also use mapping functions to provide the system for implementing routing of network traffic across one or more network nodes 120 or utilization of one or more network nodes 120 based on classification and QoS treatment of traffic flows. The control plane agent 210 may also determine one or more traffic control functions 252 (e.g., the type of automatic repeat request (ARQ), repetitive messages sent across different channel media, etc.) for information payload and control plane messages. In some embodiments, interpreter 240 may include a slow interpreter 222 that is run on a CPU and a fast interpreter 232 that is run on an NPU.

The fast agent 230 may be implemented in the data plane and be a part of the data plane agent 242, which may be a data link layer agent that may be implemented as a software engine that is executed on one or more types of processors. The data plane agent 242 transmits data payloads of the telecommunication network 110 and control plane messages with special headers that are treated as part of the data traffic. In some embodiments, to increase the speed of transmission and data processing of information payloads, the data plane may be run on an NPU. The fast agent 230 may be used to transmit control messages but use data plane resources to increase the speed of transmission.

The throttling control engine 244 controls the traffic of one or more channels of a network node 120. In some cases, throttling control engine 244 may limit the bandwidth of a particular user or a particular channel to ensure the traffic associated with the user or channel does not overburden the system. The node state engine 246 monitors the status of a network node 120, including the status of ports, links, the control plane and the data plane. The node state engine 246 also monitors the status and activities of each channel. The throttling control engine 244 may provide flow pushback to ports based on the status information provided by node state engine 246.

For example, the throttling control engine 244 obtains state information on each physical and/or logical link on the network nodes 120, or the node uses a third-party channel, for the purposes of modifying flow rates through the DLL link. The throttling control engine 244 makes decisions based on the state information, information in the configuration of the services held in the data plane 160, settings on the control plane agent 210 on how to perform flow control, or push back to restrict bandwidth rates at the network side of a network node 120 when congestion situations are encountered. The network-side port may provide end-to-end flow information. The network-facing ports may use mechanisms such as PAUSE in mapping and pause detection function, and other IP or Ethernet type congestion signaling to communicate flow control is needed by the network nodes 120.

In the embodiment shown in FIG. 2A, the network nodes 120 may communicate with each other through more than one channel. Example channels may include FSO communication 260, E-band 262, other radio frequency such as microwave (MW) 264, and additional channel media 266 and 268. The channels 260, 262, 264, 266, and 268 in FIG. 2A are examples of channels 114 and 116 in FIG. 1. The particular types of channel media (e.g., FSO and E-band) are merely shown in FIG. 2A as examples. Channels between two network nodes 120 in any embodiments may include zero to multiple FSO 260, zero to multiple E-band 262, etc. Also, among network nodes 120, there can be different types of channels between any two network nodes 120. For example, some network nodes 120 may have the same channels, while other network nodes 120 may have different channels in a telecommunication network 110. In a telecommunication network 110, a pair of network nodes 120 may be fully duplex, as represented by arrows 270 and 272. However, in some embodiments, some of the network nodes 120 may also be half duplex or simplex.

The classification functions 250, traffic control functions 252, and mapping functions 254 may include customizable variables that may be stored in a memory of a network node. Those functions may be adjustable to allow a network administrator to quickly change the settings of network nodes 120 so that those functions become “hot modifiable.” The agents, engines, and other configurations of network nodes 120 may be configured by the network management system 130 by adjusting those functions. Those functions affect how a control plane message or an information payload is transmitted across the telecommunication network 110 such as the channel used, the ARQ used, etc. For example, a telecommunication network administrator device 142 may send a new transport control function or a change in a transport control function to telecommunication network 110 through network management system 130.

The framework 200 of a network node 120 shown in FIG. 2A allows the telecommunication network 110 to implement mapping and management of network traffic across one or more network channels and nodes 120. The framework can be used to address issues with FSO channel stability, but the framework can be applied to different types of data link layer functions, link aggregation, SDN, NFV, IoT, Cloud, other solutions that use VPN, and link protocols where trunk or link aggregation type methods are implemented. The framework allows a telecommunication network 110 to perform various functions required to classify, map and un-map traffic into link flows, while providing the ability to add and subtract traffic control functions on-demand or at will.

The implementation method may utilize transmission, switching, and aggregation nodes architectures and be deployed in a single device or multiple devices. More particularly the method involves traffic classifications, mapping, QoS treatment, and data link layer functions and other functions used across a link or plurality of links to provide better service performance, and the ability to dynamically change the traffic control and mapping functions used on the traffic itself.

The network node 120 implements software-defined, highly configurable, and customizable data link layer transmission and QoS control mechanisms to provide resilience over media that suffers packet loss such as FSO and unregulated Wi-Fi. A network node 120 provides management and control plane features that provide fully customizable and extendable QoS treatments for data plane 160 via modularly defined transmission and QoS mechanisms that can be used to maintain and handle traffic flows across one or more channels.

A network node 120 includes a data plane agent 242, a control plane agent 210, a throttling control engine 244, and a node state engine 246 that are used to manage traffic between two network nodes 120. The network node 120 may include various functions such as an event and messaging function, classification, flow control, and pushback function, traffic control functions and link management, and mapping and pause detection functions that cooperate to configure and reconfigure the data plane functions. Those functions may be configured by the network management system 130.

The DLP protocols can be used to send control plane messages via a slow protocol path 228 or a fast protocol path 238, according to an embodiment. A control plane agent 210 may receive or generate one or more control plane messages. A network node 120 may receive a message when the message is transmitted from another network node 120. The message may also be originated from the network node. A control plane message may belong to the control plane 150 that is from a TCF 252. The control plane agent 210 may also receive mapping information associated with how the control plane message should be transmitted. For example, the mapping information may be a set of parameters that are part of the metadata of the control plane message. In some cases, the mapping information includes port information, traffic control functions to be used, and QoS specification. The interpreter 240 determines, based on the mapping information, whether the control plane message is to be sent via the control plane 150 or the data plane 160. The interpreter 240 may make the determination by inputting one or more parameters of the control plane message to the mapping function 254 to decide whether the control plane message is to be sent by which single or plurality of links. In some embodiments, the telecommunication network 110 includes a plurality of channels. The interpreter 240 may determine the states of the channels. The interpreter 240 then determines a mapping of the control plane message based on the mapping information and the states of the channels to determine whether the control plane message is to be sent via alternative paths when link outages occur.

If the interpreter 240 decides that the control plane message is to be sent by data plane 160, the control plane message is processed by the fast agent 230. Fast agent 230 is a control plane agent but uses data plane resources to transmit the control plane message. In response to a determination that the control plane message is to be sent via the data plane 160, the fast agent 230 may first encode the control plane message. For example, the fast agent 230 may turn the control plane message into a shorter message based on a particular mapping and classification scheme that may be defined in mapping function 254 and classification function 250. The fast agent 230 may insert the shorter message as a structured header in a data plane frame. The data plane frame may or may not include data payload of regular user traffic and a section of the data plane frame is utilized to carry control plane messages. For example, in some embodiments, a fast agent frame contains only header without payload so that the frame is small and can be transmitted really quickly. Sometimes the fast agent frame may be transmitted in the middle of two regular payload frames. The data plane frame has a marking signifying that the data plane frame carries the control plane message. In some embodiments, the marking may be part of the header and may assign values based on the control plane message type. In some embodiments, the header may include two sections that are used to encode the control plane message type. The first section may include the path identifier of the control plane message. The second section may include the QoS level identifiers of the control plane message. In some embodiments, the encoded frame (e.g., with a header that is coded with the type of control plane message) may be referred to as a codified frame that is in a specific format. In some embodiments, the specific format of the data plane frame complies with the Ethernet frame standard. In various embodiments, the fast agent 230 may also insert the control plane message or an encoded shorter version of the message into another part of a data plane frame. For example, if a control plane message includes information that may not be easily encoded to fit the space of a header, the control plane message may also be put in the body of the data plane frame.

The network node 120 transmits the data plane frame via the data plane 160 by injecting the data plane frame into a traffic of data payload frames. Data payload frames are normal information traffic of the data plane 160. The data plane frame that carries a version of the control plane message (e.g., the control plane message itself or an encoded shorter version) is identified by the marking. By transmitting a control plane message through the data plane 160, the control plane message can be propagated to other network nodes 120 in the telecommunication network 110 at line rate of a channel or close to the line rate. As a result, control plane messages can be transmitted quickly in the network and various customizable functions, such as a network traffic control function, of the network nodes 120 can become “hot modifiable” by virtue of using the reserved header space and/or different control plane messages.

At a far end network node 120B, the network node 120B receives a plurality of frames transmitted via the data plane 160. The network node 120B determines that one of the received frames includes the marking (e.g., the special header) as the data plane frame that encodes the control plane message. The network node 120B returns the control plane message to a part of a flow of the control plane 150 based on the mapping information associated with the control plane message. The network node 120B may also determine that other frames in the received frames that do not include the marking as the data payload frames and continue to route those data payloads through the data plane 160. In one case, if a marking is found in a data payload frame, the structured header that carries the control plane message is stripped off. The control plane message is forwarded to control plane 150. The rest of the data payload frame is routed through the data plane 160.

If the interpreter 240 decides that the control plane message is to be sent by control plane 150, the control plane message is processed by the slow agent 220. The slow agent 220 generates a control plane frame that encapsulates the control plane message. The network node 120, in turn, transmits the control plane frame via the control plane 150. In some cases, the network node 120 (or a channel of the node) may toggle between two states. In a first state, the data plane 160 has data traffic. In a second state, the data plane does not have data traffic. In the first state, the control plane message may be sent through the data plane 150 by injecting the data plane frame that carries the control plane message into the live traffic. In the second state, the control plane frame may be sent via the control plane 150 or be sent via the data plane 150 during a lapse of data plane traffic.

The network node agents' ability to map messages to the fast or slow agent, combined with the extendibility of interpreter using type and/or other information to add, remove, or adjust TCFs statically or dynamically by the agent or externally via API interfaces, creates a framework that supports a plethora of other network functions outside of data link layer transmission and quality control. Natively the framework can be used to support any data path function. For example, security functions such as encryption functions can be treated as TCFs where functions are configured via the agent by mapping traffic through the agents. The end-to-end security control may be passed through the fast or slow paths via a type of TCF or other delineation. Any paired or standalone (e.g., single end function) function can be treated as a TCF by the agents and the data may be sent as control plane messages. The functions may be added on-demand dynamically provided the function has a TCF type that allows the information to be mapped across one or both of the agents.

The adaptability of the frame in accordance with an embodiment will be apparent to one skilled in the arts of service chaining where a function may be a sub-component of an overall traffic service. The agents can dynamically add and/or remove TCFs, any other applications, or functions from the data plane via re-configuring the mapping elements and the setting up of the interpreter and flow. This enables the framework to host Cloud functionality as part of the protocol, as well as SDN, IoT, AIN, Machine Learning, and AI. Each of these functionalities may use system functions distributed along the transmission path. The framework may be extended to support new functions. The signaling may be mapped to the path best suited for the requirements of the control plane message.

FIG. 2B is a block diagram that illustrates the placement of DLP traffic functions 287 and 288 and classifiers 285 and 286 on a software application architecture, according to an embodiment. The classifiers 286 and 286 may take the form of header function in the DLP. The traffic functions 287 and 288 and classifiers 285 and 286 may be implemented in computing hosts 271 and 272. The computing hosts 271 and 272 have compute layers 290 and 291, each of which includes its application functions 292 and 293. The computing hosts 271 and 272 also include link control messaging agents 277 and 278. Each link control messaging agent may include an interpreter, a fast agent, and a slow agent. The functions and features of the interpreter, fast agent, and slow agent are similar to the interpreter 240, fast agent 230, and slow agent 220 shown in FIG. 2A. The header function (classifier) 285 maps Ethernet or IP protocol headers into DLP headers for traffic treatment. The Ethernet flows enter the header function (classifier) 285 and are mapped through traffic function 287 that performs functions such as ARQ for packet retransmission. The header function (classifier) 285 may also replicate flows over multiple links 274, 275, and 276. The replicated flows are recombined at the traffic function 288 and then passed on to the next header function (classifier) 286. If data is intended for a computing host, the data is transmitted to compute layer 290.

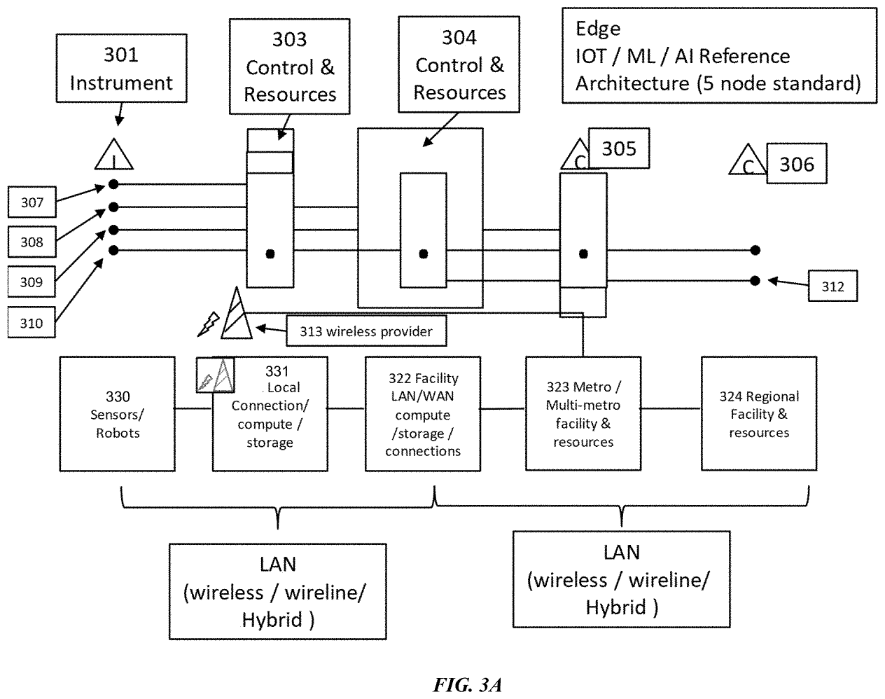

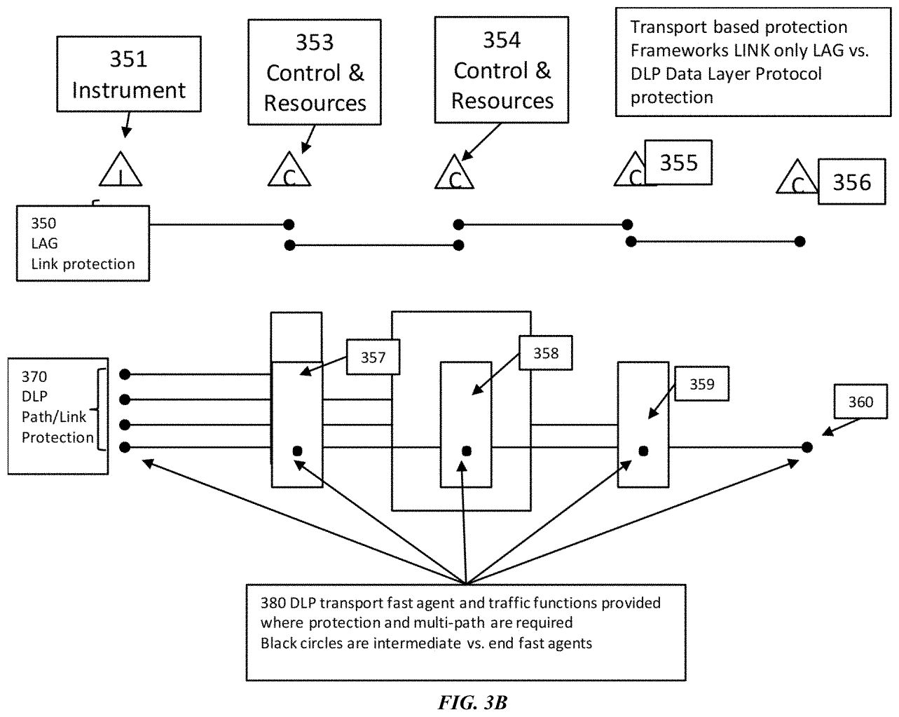

FIG. 3A is a block diagram illustrating an IoT (Internet of Things), AI (Artificial Intelligence), or ML (Machine Learning) 5 node reference architecture. Instruments 301 are located in a physical location to work with a local controller or application at a physical site. The local controller or application may be referred to as control and resources 303 and are network connected by various methods. These local control and resources 303 can be autonomous, or work under or in coordination with high level local resources 304, which may also work under or in coordination with metro, regional, or national control and resources 305 thru 306. It is often typical to have a diverse connectivity among any set of nodes in this framework, as illustrated by connections 307, 308, 309, 310, and 312. Each of those connections may represent a type of connection protocol. In example the instruments at 301 may connect directly to the controls and resources locally at 303, or 304, or may completely skip those and interact with a non-local resource such as node 305 or node 306 via alternative connectivity sources such as wireless. The sensors/robots 330, local connection 331, facility LAN 332, metro resources 323, and regional resources 324 are a set of specific examples that follow this general architecture.

FIG. 3B is a block diagram that illustrates the differences between an Ethernet LAG (logical aggregation group) protection framework and a DLP protection, according to an embodiment. The Ethernet LAG protection 350 restricts a system to have two nodes of link interfaces for each connection. Although each connection is Ethernet in nature, each connection may have a different protocol and even network provider compared to another connection in this architecture. In some embodiments, the DLP architecture 380 alters the LAG system and provides a common DLP path for the nodes in the entire system. The DLP protection 370 includes a transport fast agent and traffic functions that provide common functionality among the nodes, such as protection and traffic control. Each node includes an intermediate or end node fast agent. The DLP protection 370 is a multi-path system. For example, the instrument may communicate with the most far-end node 356 through the path 357, 358, 359, or 360. Hence, if an intermediate node such as 353 fails, the instrument may still communicate directly to the far-end node 356 directly through the path 360. Hence, the multiple paths combined may act as a BUS like path so that the nodes in the network can communicate directly to each other with or without an intermediate node.

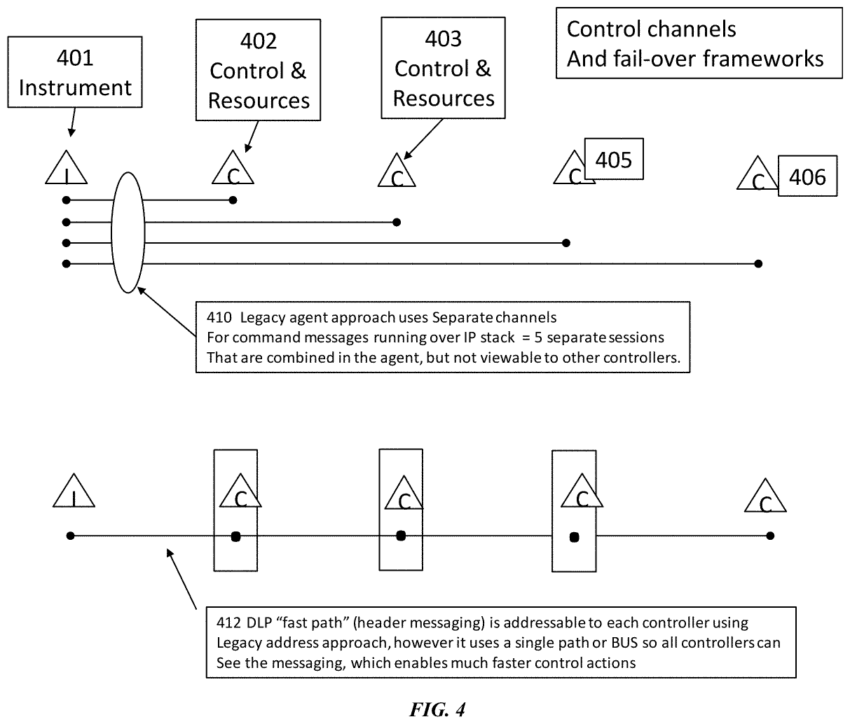

FIG. 4 is a block diagram illustrating a control channel and fail-over framework in a DLP system, according to an embodiment, compared to a conventional network system. A conventional network 410 depicts a control framework that is encountered when using the IP layer for delivering services or having a control framework across an IP layer where the remote agent must have a communication session to each IP address at different locations. In the network 410, an end device 401 communicates with the controllers or resources at 402. When network 410 becomes impaired or a failover occurs, the controller and resources at 403 have no visibility of the failure. This causes the end device 401 to have to communicate with another controller or resource to re-establish the control framework. The BUS 412 depicts a control framework used for a DLP fast path messaging. The control messages are carried upstream to the far end. The DLP fast path (header messaging) is addressable to each controller using a conventional address approach. However, the DLP system uses a single path or BUS so all controllers can see the control message. This enables much faster control actions. Nodes can “fail north” of upstream as a fall back that is typically provided with all edge computing or control schemas. In some embodiments, if a node fails, the node will by default re-transmit any messages received without processing so that the failed node is bypassed.

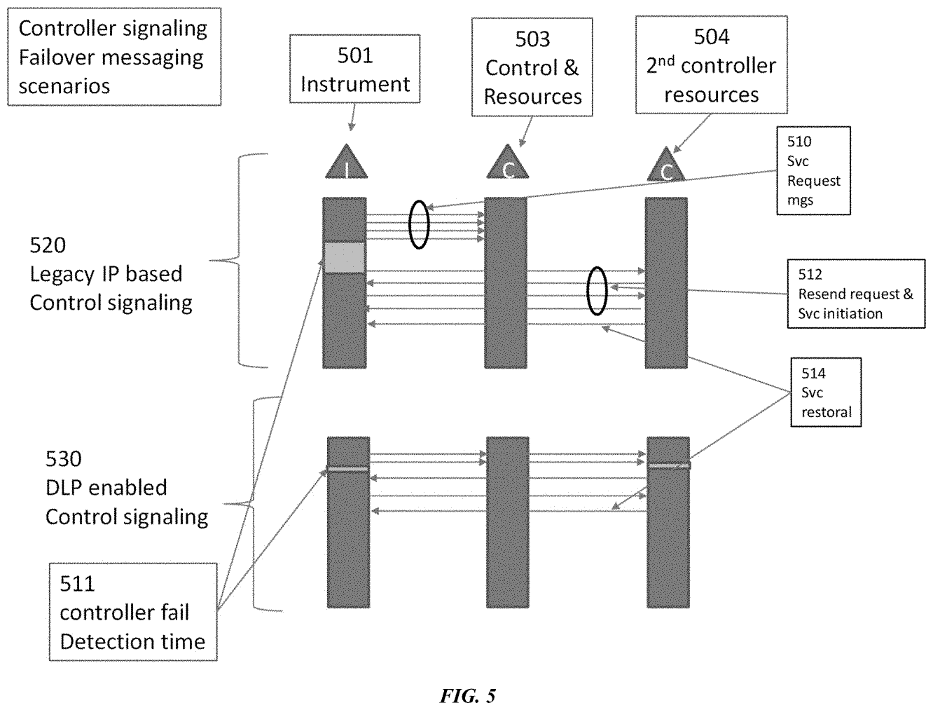

FIG. 5 further illustrates the difference between conventional control session impairment and DLP control session, according to an embodiment. Scenario 520 shows the generic control message failures on a transport system. In Scenario 520 with legacy IP based control signaling, an end device 501 (e.g., an instrument) sends messages to the node 503 (e.g., a local controller). However, the connectivity is impaired or absent. The end device 501 sends multiple requests to the node 503 until the end device 501 determines that it will need to communicate with a different controller in process 511, such as after a timeout. The end device 501 finally sends a new signal or request to the fail-over controller 504, which then re-initializes the session with the end device 501. The pair may then take action. This method lacks carrier grade type fast fail-over.

In scenario 530, the DLP transmission control function protects traffic across multiple links, according to an embodiment. The DLP transmission control function provides sub-second re-transmission of lost frames, which lowers or eliminates control frame loss. The DLP transmission control function also provides a BUS like signaling channel which applications can use. As such, the failover can be observed by other controllers and the rest of the nodes in the network when the failover occurs. In this scenario the failover controller 504 can observe that the end device 501 repeatedly requests or sends signals without being answered by the default controller 503. Both the agent and controller can immediately signal the switch of the connection without adding the wait time to determine the first controller 503 did not respond. The system provides shared knowledge to the nodes in the DLP system. Controller 504 also knows what the request was. Hence, the end device 501 does not need to re-request the service from controller 504. This is generally described as a “hot fail-over,” which is not possible to accomplish with conventional IP signaling because the control session for conventional IP system is between two addresses. The signaling approaches shift from a point to point legacy IP schema to a fast fail-over or hot fail-over using this methodology. A node may monitor if the other nodes are responsive to messaging, determine which nodes are isolated, and so on.

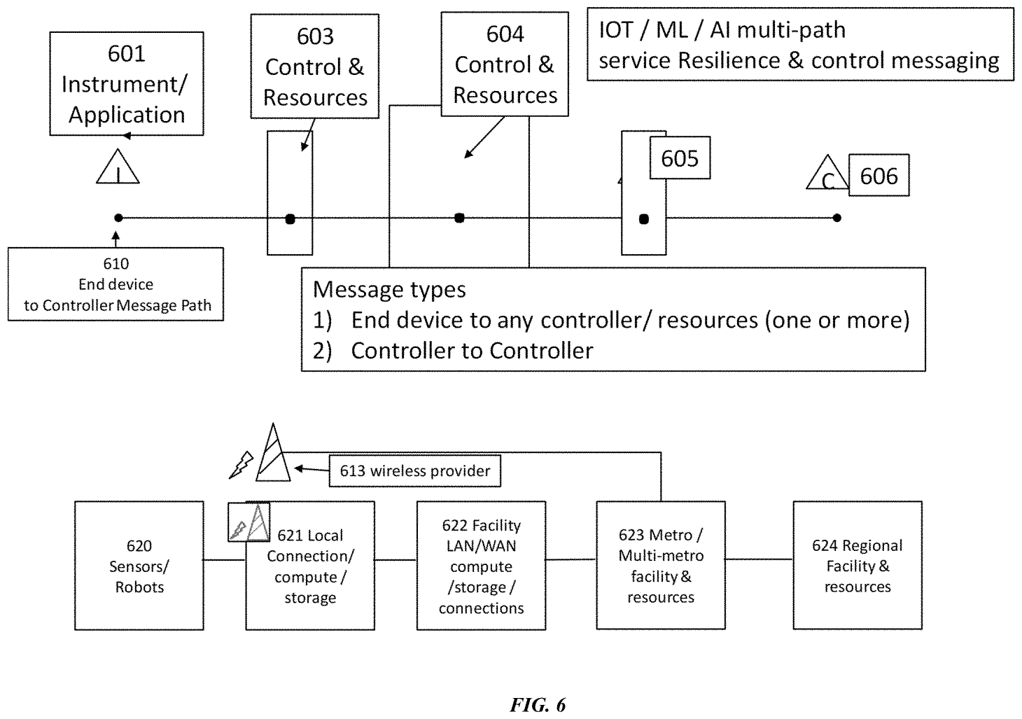

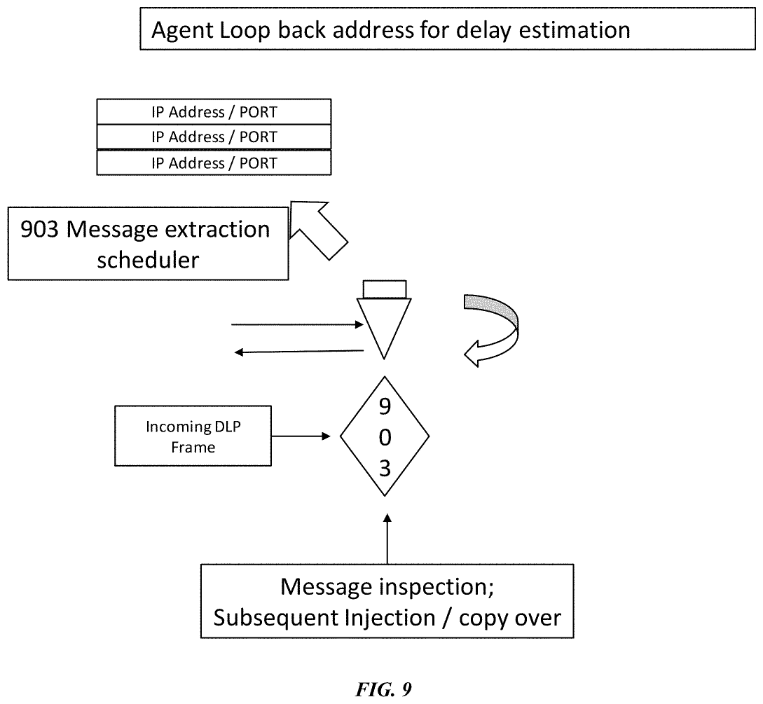

FIG. 6 depicts an IoT, AI, ML, or another control framework where multiple nodes perform specific stages throughout the control framework architecture, according to an embodiment. In this scenario, the control messages from node 601 are passed all the way up the chain to node 606 even though the control messages are only intended for a local node (e.g., controller 603). This enables node 606 to monitor the network control activities and store the status and network control activities for future analysis, such as big data ingestion, operational display, system health, etc. The “BUS” like signaling can also be used to coordinate controller hand-offs and end-device hand-offs from controller to controller. A node, using techniques in AI and ML, may evaluate event correlations between sensors based on path delay and messages using the benchmarking frames obtained from a fast agent loopback illustrated in FIG. 9. The event correlations may reveal the transmission path length. The state of end device can be visible across the system at node 606 obtained by the analysis of the northbound control messages. Advanced audit and intervention tools may also be provided along those same lines to detect faulty devices.

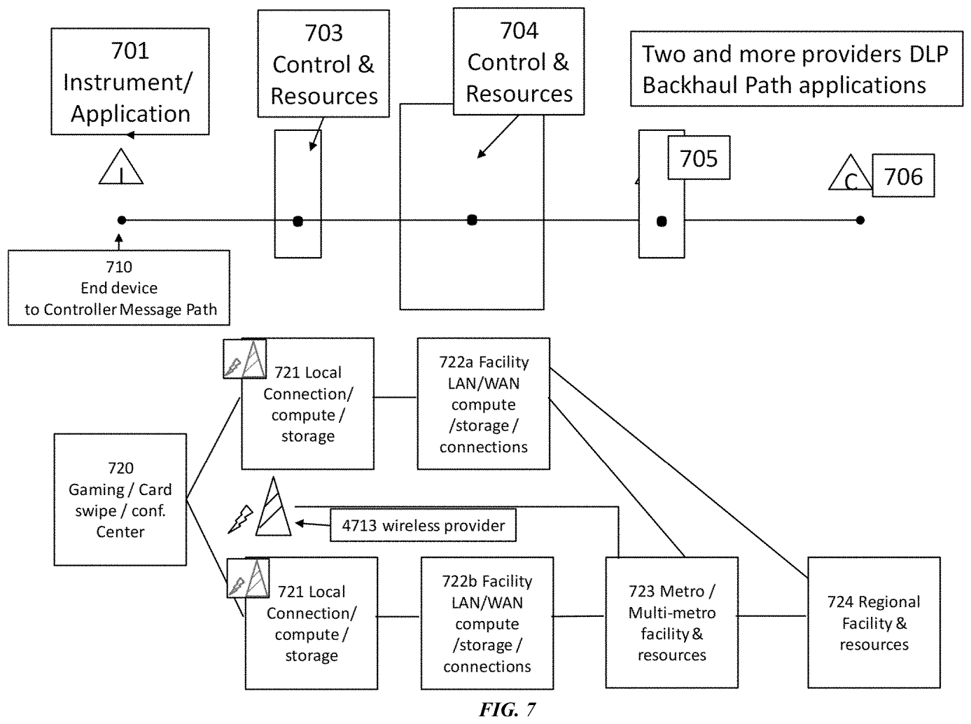

FIG. 7 is a block diagram illustrating an implementation of DLP in software applications with two or more providers, according to an embodiment. The software applications may include any suitable applications such as day-trading, gaming, or other applications. The use or control scenario can be impacted by impairments on the “active” control signaling or application path. For example, an end device 720 uses DLP protection across the Ethernet service from each provider back to service location 723 or 724. The traffic control functions protect the traffic from frame loss via ARQ and traffic replication. The traffic control functions communicate the states of various nodes and devices back to the application if the application requires state information within seconds or sub-seconds IP and MPLS networks tunnel Ethernet services, so the “Ethernet Service” can be delivered by any network providing the interface to the provider is an Ethernet hand-off. The applications can also leverage the fast message agent in DLP to ensure fast fail-over from node 723 to node 724 (or vice versa) in the event one of those nodes fails. The connection in this network is multi-path. If, for example, the facility 722b fails, the application 720 may use DLP frames via the fast agent to re-establish a connection with the metro facility 723. The facility 722b may serve a role in the network. After the re-establishment of a connection with metro facility 723, the metro facility 723 may take the role of facility 722b and becomes facility 722a and continue to service the IoT, AI, or ML process without significant interruption.

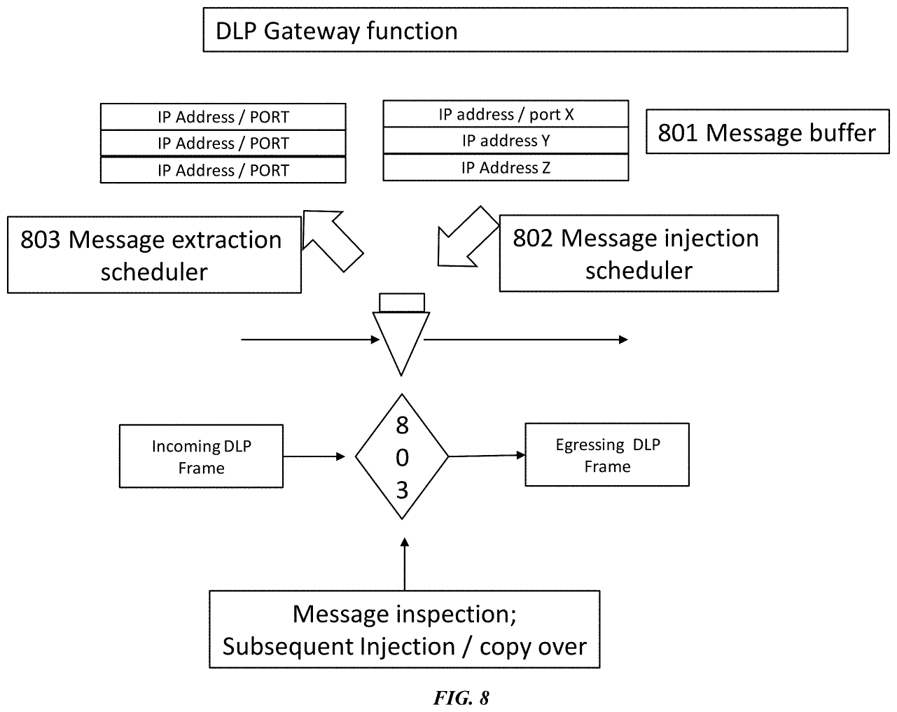

FIG. 8 depicts an IP gateway function on the DLP fast agent, according to an embodiment. The DLP fast agent can be used to tunnel or extend an IP subnet out to a device or a software agent. This feature can be applied in various use cases. The feature allows nodes to copy the control signaling and add a new dimension to the functionality, for example in situations where an operational control system has 2 controllers which fail over to each other. In cases where industrial control and IoT of a third party system need to be supported, if the system supports this type of BUS type control messaging, addressing failover of a resource (e.g., an application or a device) is not required to support DLP. The resource can simply leverage the BUS control signaling framework to achieve higher speed cutovers.

In FIG. 8, an example process for DLP message handling and frame inspection is illustrated, according to an embodiment. The message handling and frame inspection may be performed by a DLP header function. FIG. 8 depicts the behavior of the DLP header function when DLP is used across multiple applications or multiple transmission functions where some frames already contain messages. The header function includes a message injection function 802 and message extraction function 803. While some frames already contain messages, additional messages may come in from other host elements via the message buffer 801. The additional messages may be queued for transmission over the DLP headers that are available via a message injection function 802. Agents removing or copying messages off the bi-directional message flow are handled by a message extraction function 803. The messages are mapped to the appropriate source. For example, the header function receives an incoming DLP frame. The message extract function 803 determines whether there are messages in the header that are intended for the instant computing node. If so, the message extract function 803 extracts the message from the header. The header function also examiners if there are available spaces in the header. The spaces become available if a message is extracted from the header or if the header is not in full capacity. In turn, the message injection function 802 inject a new message to the DLP frame and transmits the frame to a subsequent computing node.

FIG. 9 depicts operational class functions being placed under the DLP slow agents or fast agents in order to conduct testing or other functions from operations, applications, etc. In this example a loopback address is used. The loopback address is used to check whether a point in the network or a message node is reachable. The OAM functions used by Ethernet and many of those used at the IP layer are incorporated to the agent functionality. The loopback may be used to estimate delay.

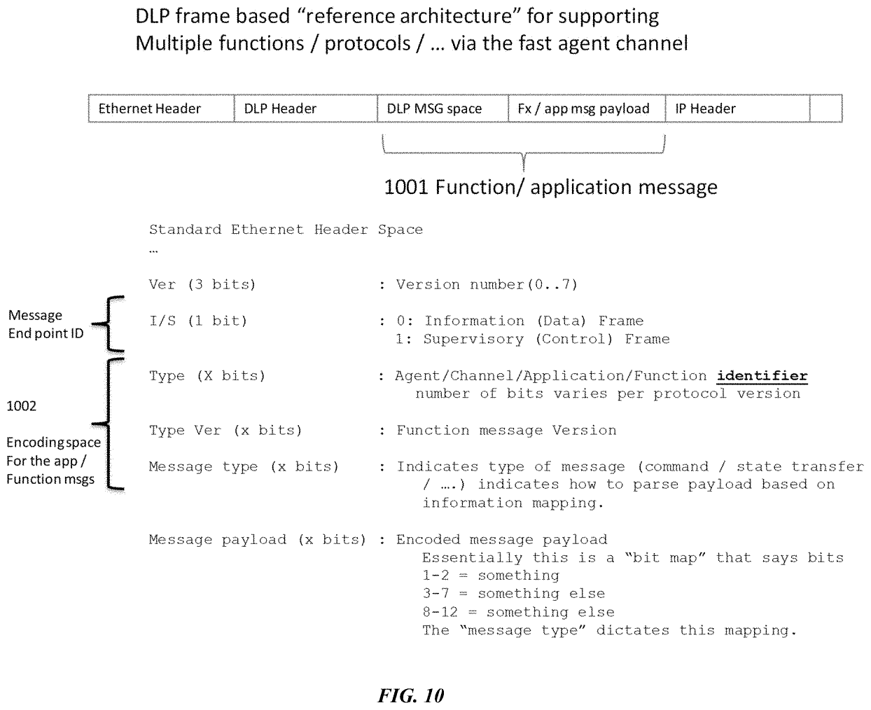

FIG. 10 depicts one of the methods for the slow agent and fast agent protocol to carry functional messaging across a link. Specific provisions are made in the messaging areas 1001 and 1002 to carry the protocol type, version, and data of the function messages being transmitted across the DLP protocol. FIG. 10 depicts an example contents of the DLP frame, which may include header message, functions and application messages, according to an embodiment. The DLP frame may be transmitted by a fast agent. In some embodiments, the frames are Ethernet so they have standard Ethernet header structure 1001. In some embodiments, the frames are Ethernet so they have standard Ethernet header structure 1001, but without a payload. The DLP frame may be used to send control message. Since the DLP frame may have only the header, the frame can be transmitted as quickly as possible, such as under the line rate of the network. Each frame contains message information 1002 that relates to the type of message. Each frame may also include the function messages or the application messages. Function messages or application message are messages sent from a host function or an application. There can be various encoding, encapsulation, versioning, and protocol methods. The system uses a fast agent as a transmission facility to applications, management, control, etc. In some embodiments, the system does not use the IP/TCP layers that often have jitter buffers and slow re-transmission that is not sufficient for the control of time sensitive systems. It should be noted that the fast agent can also generate a frame-based message in a standard protocol packet creation fashion and insert it in the bearer path at line rate. The function message or application message may be included in the header of the frame.

### Computing Machine Architecture

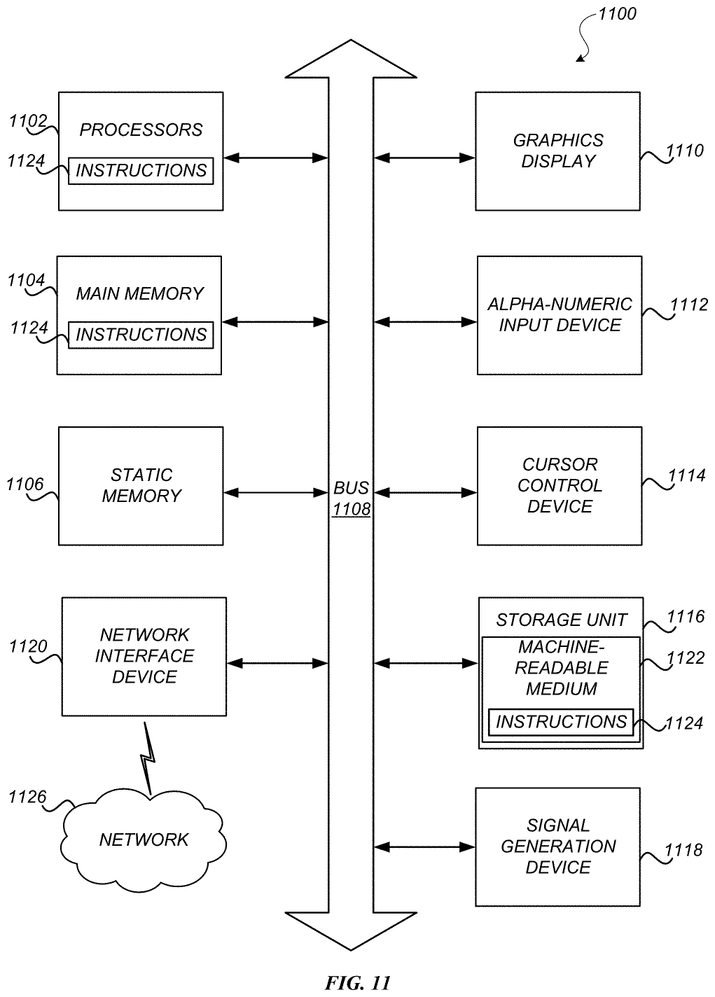

FIG. 11 is a block diagram illustrating components of an example computing machine that is capable of reading instructions from a computer-readable medium and execute them in a processor (or controller). A computer described herein may include a single computing machine shown in FIG. 11, a virtual machine, a distributed computing system that includes multiples nodes of computing machines shown in FIG. 11, or any other suitable arrangement of computing devices.

By way of example, FIG. 11 shows a diagrammatic representation of a computing machine in the example form of a computer system 1100 within which instructions 1124 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 11 may correspond to any software, hardware, or combined components shown in FIGS. 1 and 2, including but not limited to, the telecommunication network administrator device 142, the network management system 130, and various engines and agents shown in FIG. 2. While FIG. 11 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1124 that specify actions to be taken by that machine. Further, while only a single machine is illustrated, the term “machine” and “computer” may also be taken to include any collection of machines that individually or jointly execute instructions 1124 to perform any one or more of the methodologies discussed herein.

The example computer system 1100 includes one or more processors 1102 such as a CPU (central processing unit), a network processing unit (NPU), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1100 may also include a memory 1104 that store computer code including instructions 1124 that may cause the processors 1102 to perform certain actions when the instructions are executed, directly or indirectly by the processors 1102. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 1102 and reduces the space required for the memory 1104. For example, the processing techniques described herein may reduce the complexity of the computation of the processors 1102 by applying one or more novel techniques that simplify the steps in generating results of the processors 1102. The processors described herein also speed up the processors 1102 and reduce the storage space requirement for memory 1104.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 1100 may include a main memory 1104, and a static memory 1106, which are configured to communicate with each other via a bus 1108. The computer system 1100 may further include a graphics display unit 1110 (e.g., a plasma display panel (PDP), a liquid crystal display (LCD), a projector, or a cathode ray tube (CRT)). The graphics display unit 1110, controlled by the processors 1102, displays a graphical user interface (GUI) to display one or more results and data generated by the processes described herein. The computer system 1100 may also include alphanumeric input device 1112 (e.g., a keyboard), a cursor control device 1114 (e.g., a mouse, a trackball, a joystick, a motion sensor, or other pointing instrument), a storage unit 1116 (a hard drive, a solid state drive, a hybrid drive, a memory disk, etc.), a signal generation device 1118 (e.g., a speaker), and a network interface device 1120, which also are configured to communicate via the bus 1108.

The storage unit 1116 includes a computer-readable medium 1122 on which is stored instructions 1124 embodying any one or more of the methodologies or functions described herein. The instructions 1124 may also reside, completely or at least partially, within the main memory 1104 or within the processor 1102 (e.g., within a processor's cache memory) during execution thereof by the computer system 1100, the main memory 1104 and the processor 1102 also constituting computer-readable media. The instructions 1124 may be transmitted or received over a network 1126 via the network interface device 1120.

While computer-readable medium 1122 is shown in an example embodiment to be a single medium, the term “computer-readable medium” should be taken to include a single medium or multiple media (e.g., a centralized or distributed database, or associated caches and servers) able to store instructions (e.g., instructions 1124). The computer-readable medium may include any medium that is capable of storing instructions (e.g., instructions 1124) for execution by the processors (e.g., processors 1102) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

In some embodiments, a method for implementing a communication network for an Internet of Thing (IoT) application is described. The computer-implemented method includes establishing a multi-path connection among a plurality of data link protocol (DLP) nodes, at least one of the DLP nodes being an IoT device, each DLP node comprising a slow agent and a fast agent, the slow agent configured to transmit data payloads through Ethernet frames and the fast agent configured to transmit control messages through DLP frames, each DLP frame comprising a header only without a payload and the header carrying a control message. The computer-implemented method also includes determining, at a first DLP node of the plurality of DLP nodes, a second DLP node has failed, the second DLP node associated with a role in the communication network. The computer-implemented method further includes transmitting, by the first DLP node, a DLP frame carrying the control message to the plurality of DLP nodes in the communication network. The computer-implemented method further includes re-establishing a connection between the first DLP node and a third DLP node based on the control message, wherein the third DLP node takes over the role of the second DLP node.

In some embodiments, the fast agent for at least one of the DLP nodes provides an operations, administration, or management (OAM) channel for codified application control signaling.

In some embodiments, wherein the fast agents of the DLP nodes monitor connection states for other DLP nodes in the communication network and are capable of providing state change message to a software application in the communication network using a DLP frame.

In some embodiments, the DLP frames are used to conduct resource or system control failover and restoration functions.

In some embodiments, the multi-path connection includes a first path that connects the first and second DLP nodes and a second path that connects the first and third DLP nodes.

In some embodiments, the first path and the second path are provided by different network providers.

In some embodiments, the third DLP node takes over the role of the second DLP node without waiting for a timeout between the first and second DLP nodes.

In some embodiments, the control message is broadcasted to the plurality of DLP nodes so that the plurality of DLP nodes are notified of a state of the second DLP node.

In some embodiments, the control message is transmitted as controller to controller signaling.

In some embodiments, the DLP frame is injected into traffic of the Ethernet frames, and wherein the DLP frame is treated as an Ethernet frame but without the payload.

In some embodiments, at least two of the DLP nodes are software applications.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used. Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method for implementing a communication network for an Internet of Thing (IoT) application, the computer-implemented method comprising:
establishing a multi-path connection among a plurality of data link protocol (DLP) nodes, at least one of the DLP nodes being an IoT device, each DLP node comprising a slow agent and a fast agent, the slow agent configured to transmit data payloads through Ethernet frames and the fast agent configured to transmit control messages through DLP frames, each DLP frame comprising a header only without a payload and the header carrying a control message;
determining, at a first DLP node of the plurality of DLP nodes, a second DLP node has failed, the second DLP node associated with a role in the communication network;
transmitting, by the first DLP node, a DLP frame carrying the control message to the plurality of DLP nodes in the communication network; and
re-establishing a connection between the first DLP node and a third DLP node based on the control message, wherein the third DLP node takes over the role of the second DLP node.

2. The computer-implemented method of claim 1, wherein the fast agent for at least one of the DLP nodes provides an operations, administration, or management (OAM) channel for codified application control signaling.

3. The computer-implemented method of claim 1, wherein the fast agents of the DLP nodes monitor connection states for other DLP nodes in the communication network and are capable of providing state change message to a software application in the communication network using a DLP frame.

4. The computer-implemented method of claim 1, wherein the DLP frames are used to conduct resource or system control failover and restoration functions.

5. The computer-implemented method of claim 1, wherein the multi-path connection includes a first path that connects the first and second DLP nodes and a second path that connects the first and third DLP nodes.

6. The computer-implemented method of claim 5, wherein the first path and the second path are provided by different network providers.

7. The computer-implemented method of claim 1, wherein the third DLP node takes over the role of the second DLP node without waiting for a timeout between the first and second DLP nodes.

8. The computer-implemented method of claim 1, wherein the control message is broadcasted to the plurality of DLP nodes so that the plurality of DLP nodes are notified of a state of the second DLP node.

9. The computer-implemented method of claim 1, wherein the control message is transmitted as controller to controller signaling.

10. The computer-implemented method of claim 1, wherein the DLP frame is injected into traffic of the Ethernet frames, and wherein the DLP frame is treated as an Ethernet frame but without the payload.

11. The computer-implemented method of claim 1, wherein at least two of the DLP nodes are software applications.

12. A system comprising:
a plurality of data link protocol (DLP) nodes, at least one of the DLP nodes being an IoT device, each DLP node comprising a slow agent and a fast agent, the slow agent configured to transmit data payloads through Ethernet frames and the fast agent configured to transmit control messages through DLP frames, each DLP frame comprising a header only without a payload and the header carrying a control message, wherein the first DLP node is configured to:
establish, at an application layer, data traffic with the second DLP node, establish a multi-path connection other DLP nodes;
determine that a second DLP node has failed, the second DLP node associated with a role in the communication network;
transmit a DLP frame carrying the control message to the plurality of DLP nodes in the communication network; and
re-establishing a connection between the first DLP node and a third DLP node based on the control message, wherein the third DLP node takes over the role of the second DLP node.

13. The system of claim 12, wherein the fast agent for at least one of the DLP nodes provides an operations, administration, or management (OAM) channel for codified application control signaling.

14. The system of claim 12, wherein the fast agents of the DLP nodes monitor connection states for other DLP nodes in the communication network and are capable to provide state change message to a software application in the communication network using a DLP frame.

15. The system of claim 12, wherein the DLP frames are used to conduct resource or system control failover and restoration functions.

16. The system of claim 12, wherein the multi-path connection includes a first path that connects the first and second DLP nodes and a second path that connects the first and third DLP nodes.

17. The system of claim 16, wherein the first path and the second path are provided by different network providers.

18. The system of claim 12, wherein the third DLP node takes over the role of the second DLP node without waiting for a timeout between the first and second DLP nodes.

19. The system of claim 12, wherein the control message is broadcasted to the plurality of DLP nodes so that the plurality of DLP nodes are notified of a state of the second DLP node.

20. The system of claim 12, wherein the control message is transmitted as controller to controller signaling.
